(19) United States
(12) Patent Application Publication
(10) Pub. No.: US 2006/0246298 A1
(43) Pub. Date: Nov. 2, 2006

(54) Anti-fog panel

(76) Inventor: Wen-Yu Wu, Linkou Township (TW)

Correspondence Address: GARMIN CORPORATION, ATTN: Legal - IP, 1200 EAST 151ST STREET, OLATHE, KS, 66062, US

(21) Appl. No.: 11/327,441

(22) Filed: Jan. 9, 2006

(30) Foreign Application Priority Data
Apr. 27, 2005 (TW) 94113552

(51) Int. Cl. B32B 17/06; B32B 27/36; B32B 27/30; B32B 23/04

(52) U.S. Cl. 428/426; 428/480; 428/522; 428/532

(57) ABSTRACT

An anti-fog panel includes a transparent plate disposed on the housing of an electric device to form a transparent area, where the display panel inside the housing can be seen, and generate a protection effect. A plastic thin film, which has a thermal conductivity smaller than the thermal conductivity of the transparent plate, is further adhered to the side of the transparent plate that faces the inside of the housing, to prevent the heat from transferring through the transparent plate. Therefore water vapor condensing can be avoided because the temperature inside the transparent plate will not be close to the temperature outside.

### CROSS-REFERENCE TO RELATED APPLICATIONS

This non-provisional application claims priority under 35 U.S.C. § 19(a) on Patent Application No(s). 94113552 filed in Taiwan, R.O.C. on Apr. 27, 2005, the entire contents of which are hereby incorporated by reference.

### BACKGROUND

1. Field of Invention

The invention relates to an improvement of a glass panel, especially to an anti-fog panel with a plastic thin film to change the heat transfer properties thereof for preventing the water vapor from condensing.

2. Related Art

A portable electronic device such as a personal digital assistant (PDA), a laptop or a portable global position system (GPS) device is frequently used in an open environment. Therefore portable electronic devices must particularly be designed to survive in a bad environment. Generally, a portable electronic device includes a monitor, for instance a thin, light liquid crystal display according to the present display technology. Please refer to FIG. 1, showing an application of a liquid crystal display, where a display panel 2 is disposed inside a housing 1 and an image can be formed on the display panel 2 by a light projecting from a backlight module 3. The image can be watched through an opening 1a on the front side of the housing 1. In order to protect the display panel 2 against damage and maintain the tightness of the housing 1, a transparent tempered glass plate 4 or a touch panel covers the opening 1a for not just protecting the display panel 2 but also providing operation through the icons on it.

Electronic devices can be seriously damaged by water. For example, a short circuit may happen or an electric element may rust, due to the permeation of water. Although the housing 1 of the portable electric devices can block the water, it cannot protect an electronic device sufficiently. When a portable electronic device is in operation, an element will generate heat and produce a higher temperature inside. Although a higher temperature can prevent the water vapor from condensing inside, the higher temperature will raise the inside saturated vapor pressure, which becomes higher than the pressure outside the housing 1. Because the tempered glass plate 4 is made by a material which transfers heat easily, when the water vapor touches the tempered glass plate 4, the temperature inside the tempered glass plate 4 surface will be very close to the temperature outside. Therefore, condensing will happen and forms a tiny water drop, producing fog inside the tempered glass plate 4 surface when a water vapor with a higher saturated vapor pressure inside the housing 1 touches a lower temperature tempered glass plate 4. The fog will make the tempered glass plate 4 opaque and blur the image produced from the display panel 2. If the condensing produces a lot of water drops, these drops might permeate into the electric element and cause damages.

Heating is a common method for defogging the tempered glass plate 4. Thin heating wires are adhered to the surroundings or the inner surface of the tempered glass plate 4 to heat the tempered glass plate 4, raising the inside surface's temperature and preventing the water vapor from condensing. However, given the fact that portable electric devices become thinner, lighter and smaller, the space inside the device is too limited to accommodate the extra heating wires and the circuit necessary to activate the heating wires. Also, because a portable electric device is powered by a battery, making a low electricity consuming requirement become necessary and critical, the increase of the electricity consumed by using the heating wires does not conform to the low electricity consuming requirements. Another common used method is chemistry coating a film on the tempered glass plate 4 or permeating a chemical agent into it, to change its interface property, making water vapor condensation almost impossible. However, coating a film or permeating a chemical agent costs a lot and they only can decrease the condensation rate. After a longtime operation, the water still cumulates and the fog still exists, not solving the problem.

### SUMMARY

A transparent panel must be set up in the front end of the display panel to protect it. However, water vapor easily condenses inside the transparent panel surface, forming fog, blurring the image. Besides, excessive condensed water damages the internal elements. Therefore, according to the foregoing problem, the object of the invention is to provide an anti-fog panel, having the advantages of a simple structure, convenient manufacturing, and avoiding fogging and water condensing.

The invention provides an anti-fog panel where a plastic thin film is adhered to one side of the transparent plate. Because the thermal conductivity of plastic material is lower than that of glass material and because the specific heat of the plastic material is higher than that of the glass material, the temperature differences between the two sides of the transparent plate will be increased, making the temperature of the side that the plastic film is adhered to hard to change. When setting up the transparent plate covering the opening of the housing with the side that the plastic film is adhered to facing the inside of the housing, the plastic thin film can serve as thermal isolation. At that time, the inner surface of the transparent plate will not be affected by the outside temperature, where the inner surface temperature of the transparent plate will be close to the internal temperature of the housing. Therefore, the water vapor will not condense at the side where the transparent plate faces the inside of the housing, because of the temperature drop of the transparent plate. Then the transparent plate remains clear.

By practicing the invention, one advantage is the anti-fog effect by isolating the heat and avoiding the temperature drop of the transparent plate, which can be achieved just by adhering a plastic thin film. No extra heating device or special material for the transparent plate is necessary. Therefore the anti-fog panel can be simplified and costs can be reduced.

### BRIEF DESCRIPTION OF THE DRAWINGS

The present invention will become more fully understood from the detailed description given below, which is for illustration only and thus is not limitative of the present invention, wherein:

FIG. 1 is a cross section view showing a traditional tempered glass plate disposed on an electric device;

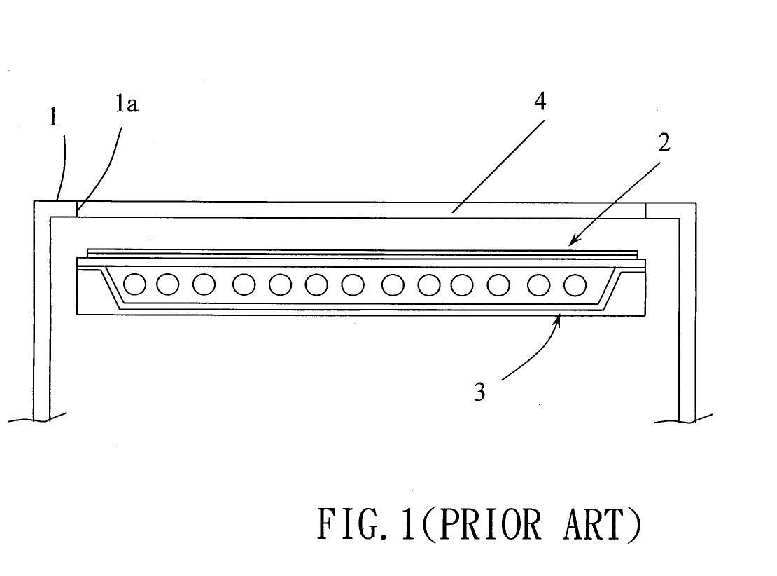

FIG. 2 is a cross section view showing the first preferred embodiment disposed on an electric device;

FIG. 3 is a cross section view showing the second preferred embodiment disposed on an electric device; and

FIG. 4 is a cross section view showing the fourth preferred embodiment disposed on an electric device.

### DETAILED DESCRIPTION

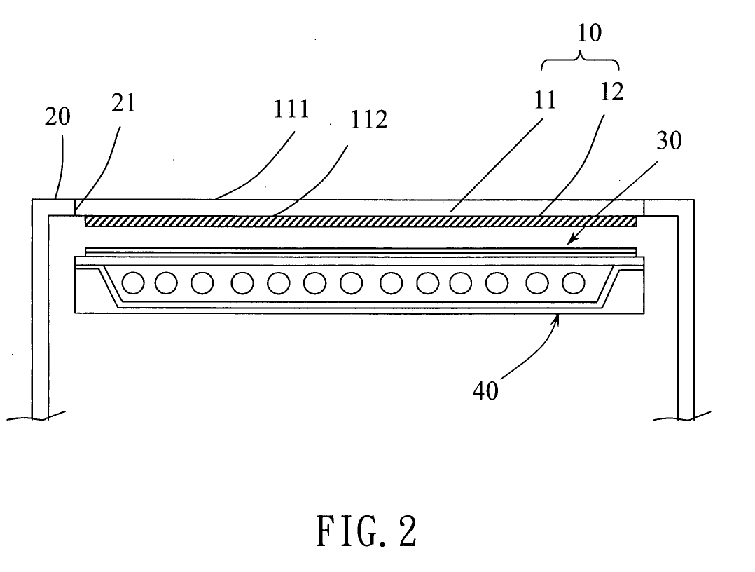

Please refer to FIG. 2, showing the first preferred embodiment of an anti-fog panel, which is disposed on the surface of an electric device, forming a transparent area. The electric device can be a personal digital assistant (PDA), a portable global position system (GPS) device or a computer display. The electric device includes a housing 20, in which is a display panel 30. The housing 20 includes an opening 21, facing the display panel 30, which forms an open area. The other side of the display panel 30, opposite to the opening 2, has a backlight module 40 to project light to the display panel, to form an image. An anti-fog panel 10 is disposed at the opening for sealing the housing, in order to protect the display panel 30 and prevent material from getting into the housing 20.

The anti-fog panel 10 includes a transparent plate 11 and a plastic thin film 12. The plastic plate 11 has an outer surface 111 and an inner surface 112. The outer surface is outside of the housing 20 and the inner surface 112 faces the display panel 30 for protecting the display panel 30. The plastic thin film 12 is adhered to the inner surface of the plastic plate 11 to serve as thermal isolation.

Practically, the transparent plate 11 can be a tempered glass plate, which has high rigidity to avoid wearing, even crashing caused by impact. However, because it has a high thermal conductivity and because it is thin, the heat resistance (R=L/KA) between the inner and outer surfaces of the transparent plate 11 is low, therefore the temperature of the inner surface 112 of the transparent plate 11 will be very close to the temperature outside the housing 20. Inside the housing 20, the saturated vapor pressure and the absolute humidity are higher because of a higher temperature. So when a higher temperature and a higher pressure vapor touch the lower temperature transparent plate 11, the temperature of the vapor rapidly drops, making the vapor condense and get in contact with the inner surface of the transparent plate 11. At that time, because the plastic thin film 12, made by a plastic material such as a polyethylene terephthalate (PET), an acrylic or a polymethyl methacrylate (PMMA) or a tri-acetate cellulose (TAC), has a thermal conductivity smaller than the thermal conductivity of glass and can increase the overall heat resistant of the transparent plate 11. Because the specific heat of the plastic thin film 12 is higher than that of glass, the temperature hardly changes and the heat transferring between the outer surface 111 and the inner surface 112 of the transparent plate 11 will be isolated. As a result, the temperatures of the transparent plate 11 and the plastic thin film 12 can be close to the temperature inside the housing 20. Because the temperatures of the transparent plate 11 and the plastic thin film 12 are close to the temperature inside of the housing 20, the water vapor is hard to condense even the air inside the housing 20 includes water vapor. Therefore the inner surface of the transparent plate 11 may not be blurred by the fog so that it can stay clear. Then the display panel 30 can display a clear image. Further, the internal circuit will not be damaged because of condensing water.

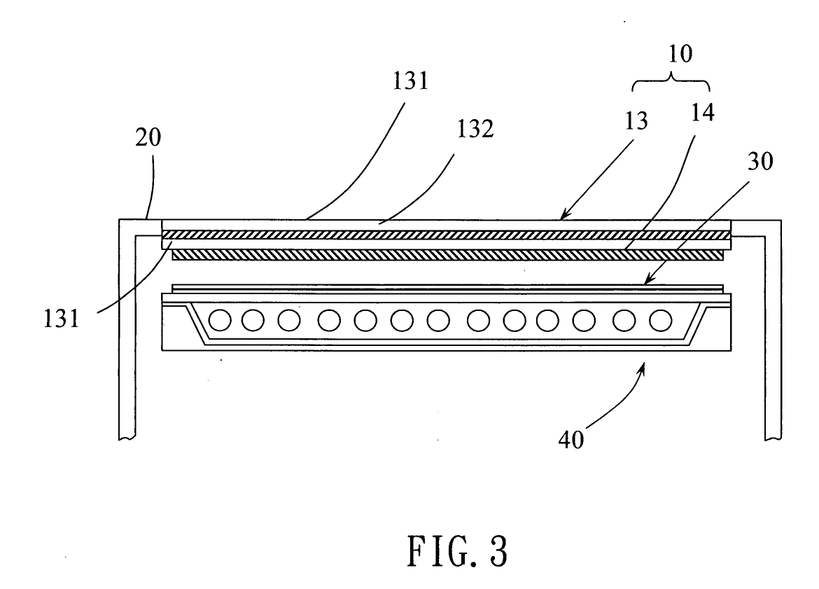

Please refer to FIG. 3, showing the second preferred embodiment of an anti-fog panel 10, which is disposed on an electric device. The electric device includes a housing 20, a display panel 30 and a backlight module 40. They are almost the same as the former embodiment except that the anti-fog panel is composed of a touch panel 13 and a plastic thin film 14. The touch panel 13 is a transparent plate, where light can pass through. A user can directly press an icon displayed on the touch panel 13 to operate the electronic device. The touch panel 13 includes three major types: a capacitance type, a resistance type and an electromagnetic induction type, which has to be activated by a stylus. The common structure of the touch panel 13 includes an actuation layer 132 between the two glass plates 131 for detecting the pressing signal. If there is only one glass plate 131, the actuation layer 132 will be set up right under the glass plate 131. Usually, the actuation layer 132 is a combination of a metal material and a glass material. Therefore, overall, the touch panel 13 will have a high thermal conductivity, where the fog-condensing phenomenon also happens. After adhering a plastic thin film 14 to the inner surface of the touch panel 13, the heat loss can be avoided, making the temperature of the inner surface of the touch panel 13 to be close to that inside the housing 20. Thus, the fog will not condense.

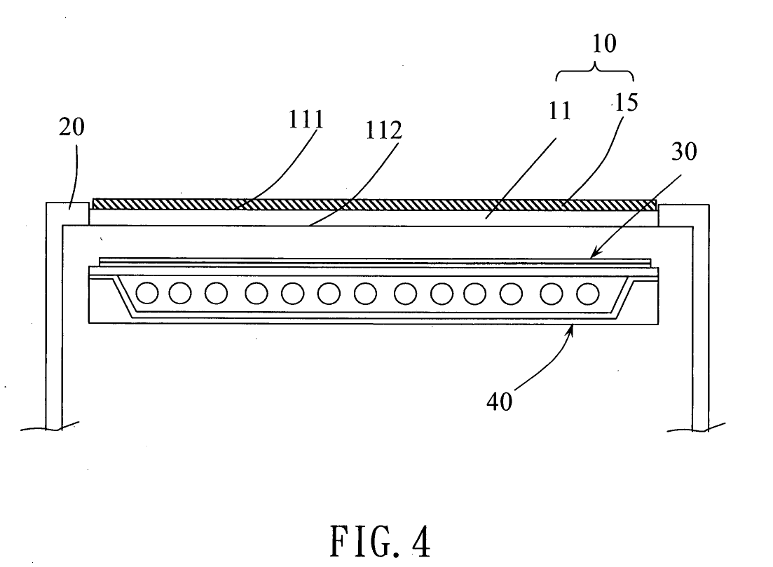

Please refer to FIG. 4, showing the third preferred embodiment of an anti-fog panel 10, which is disposed on an electric device. The electric device includes a housing 20, a display panel 30 and a backlight module 40. The anti-fog panel 10 is composed of a transparent plate 11 and a plastic thin film 15. In comparison with the first preferred embodiment, this plastic thin film 15 is adhered to the outer surface 111 of the transparent plate to directly isolate the heat from transferring outside, making the overall temperature of the plastic plate 11 be close to the internal temperature of the housing 20. Therefore the water vapor will not condense on the inner surface of the transparent plate 11, making the transparent plate 11 clear by preventing the fog from condensing.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. An anti-fog panel disposing at an opening of a housing to protect a display panel inside the housing, the anti-fog panel comprising:
a transparent plate including an inner surface and an outer surface, wherein the transparent plate is disposed at the opening of the housing with the inner surface facing the display panel for protecting the display panel; and
a plastic thin film having a thermal conductivity smaller than the thermal conductivity of the transparent plate wherein the plastic thin film is adhered to the inner surface of the transparent plate for isolating heat from transferring through the transparent plate to outside, avoiding water vapor condensing on the inner surface of the transparent plate because of a low temperature.

2. The anti-fog panel of claim 1 wherein the plastic thin film is made by polyethylene terephthalate (PET).

3. The anti-fog panel of claim 1 wherein the plastic thin film is made by acrylic or a polymethyl methacrylate (PMMA).

4. The anti-fog panel of claim 1 wherein the plastic thin film is made by tri-acetate cellulose (TAC).

5. The anti-fog panel of claim 1 wherein the transparent plate is a tempered glass plate.

6. The anti-fog panel of claim 1 wherein the transparent plate is a touch panel.

7. An anti-fog panel disposing at an opening of a housing to protect a display panel inside the housing, the anti-fog panel comprising:
a transparent plate including an inner surface and an outer surface, wherein the transparent plate is disposed at the opening of the housing with the inner surface facing the display panel for protecting the display panel; and
a plastic thin film having a thermal conductivity smaller than the thermal conductivity of the transparent plate wherein the plastic thin film is adhered to the outer surface of the transparent plate for isolating heat from transferring through the transparent plate to outside, avoiding water vapor condensing on the inner surface of the transparent plate because of a low temperature.

8. The anti-fog panel of claim 7 wherein the plastic thin film is made by polyethylene terephthalate (PET).

9. The anti-fog panel of claim 7 wherein the plastic thin film is made by acrylic or a polymethyl methacrylate (PMMA).

10. The anti-fog panel of claim 7 wherein the plastic thin film is made by tri-acetate cellulose (TAC).

11. The anti-fog panel of claim 7 wherein the transparent plate is a tempered glass plate.

12. The anti-fog panel of claim 7 wherein the transparent plate is a touch panel.
